(19) United States
(12) Patent Application Publication
(10) Pub. No.: US 2022/0213788 A1
(43) Pub. Date: Jul. 7, 2022

(54) INFORMATION TRANSMISSION SYSTEM, TRANSMITTER, RECEIVER, AND INFORMATION TRANSMISSION METHOD

(71) Applicant: JAPAN AVIATION ELECTRONICS INDUSTRY, LIMITED, Tokyo (JP)

(72) Inventors: Hiroshi ARITA, Irvine, CA (US); Yasuhiro SATO, Irvine, CA (US)

(73) Assignee: JAPAN AVIATION ELECTRONICS INDUSTRY, LIMITED, Tokyo (JP)

(21) Appl. No.: 17/337,838

(22) Filed: Jun. 3, 2021

Related U.S. Application Data
(60) Provisional application No. 63/134,643, filed on Jan. 7, 2021.

(51) Int. Cl. E21B 47/18

(52) U.S. Cl. CPC E21B 47/18

(57) ABSTRACT

An information transmission system of the present invention transmits information by using a mud pulse pressure signal to transmit information between a transmitter located in an excavation part of an underground excavator and a receiver located on the ground. The transmitter comprises a transmission information acquisition part for acquiring information, and a pressure pulse generation part. The pressure pulse generation part generates a pressure pulse so that an interval between the pressure pulse and a just preceding or just subsequent pressure pulse is an interval corresponding to the information acquired by the transmission information acquisition part. The receiver comprises a pressure pulse detection part for detecting a pressure pulse, and a reception information output part. The reception information output part outputs information corresponding to the interval between the detected pressure pulse and a just preceding or just subsequent pressure pulse.

### BACKGROUND OF THE INVENTION

The present invention relates to an information transmission system, a transmitter, a receiver, and an information transmission method for transmitting information by using a mud pulse pressure signal (a signal to be transmitted in the form of a pressure pulse using mud as a transmission medium) to transmit information between a transmitter located in an excavation part of an underground excavator and a receiver located on the ground.

U.S. Pat. No. 7,573,397 B2 (hereinafter referred to as “Patent Literature 1”) discloses that pulse position modulation is used in a communication method using a difference in mud pressure. Patent Literature 1 discloses an underground excavator located in the ground, a receiver located on the ground, etc.

### SUMMARY OF THE INVENTION

However, communication using a mud pulse pressure signal can transmit only about one pulse per second, so that the communication speed (the number of bits that can be transmitted per second) is extremely slow as compared with general communication. The present invention has an object to increase the communication speed of a communication method using a mud pulse as much as possible.

An information transmission system of the present invention transmits information by using a mud pulse pressure signal to transmit information between a transmitter located in an excavation part of an underground excavator and a receiver located on the ground. The transmitter comprises a transmission information acquisition part for acquiring information, and a pressure pulse generation part. The pressure pulse generation part generates a pressure pulse so that an interval between the pressure pulse and a just preceding or just subsequent pressure pulse is an interval corresponding to the information acquired by the transmission information acquisition part. The receiver comprises a pressure pulse detection part for detecting a pressure pulse, and a reception information output part. The reception information output part outputs information corresponding to the interval between the detected pressure pulse and a just preceding or just subsequent pressure pulse.

### EFFECT OF THE INVENTION

In the pulse position modulation, information is transmitted according to a timing (position) at which a pulse exists in a certain period of time. In the information transmission system of the present invention, an interval from a just preceding or just subsequent pressure pulse is made to correspond to information to be transmitted. Therefore, a standby time can be eliminated, and thus the communication speed can be improved.

### BRIEF DESCRIPTION OF THE DRAWINGS

FIG. 1 is a diagram showing a configuration example of an information transmission system of the present invention;

FIG. 2 is a diagram showing a processing flow using the information transmission system of the present invention:

FIG. 3 is a diagram showing an example in which 1-bit information is subjected to pulse position modulation;

FIG. 4 is a diagram showing an example in which 2-bit information is subjected to pulse position modulation;

FIG. 5 is a diagram showing an example in which 3-bit information is subjected to pulse position modulation;

FIG. 6 is a diagram showing another example in which 3-bit information is subjected to pulse position modulation;

FIG. 7 is a diagram showing pulses when “000011” is transmitted by the pulse position modulation shown in FIG. 6;

FIG. 8 is a diagram showing pulses when “010110” is transmitted by the pulse position modulation shown in FIG. 6;

FIG. 9 is a diagram showing an example of a modulation method that specifies information based on a period of time before a pulse;

FIG. 10 is a diagram showing a difference between a case where “000011” is transmitted by the modulation of FIG. 6 and a case where “000011” is transmitted by the modulation of FIG. 9;

FIG. 11 is a diagram showing a difference between a case where “010110” is transmitted by the modulation of FIG. 6 and a case where “010110” is transmitted by the modulation of FIG. 9;

FIG. 12 is a diagram showing an example of a modulation method that specifies information based on a period of time after a pulse;

FIG. 13 is a diagram showing a difference between a case where “000011” is transmitted by the modulation of FIG. 6 and a case where “000011” is transmitted by the modulation of FIG. 12; and

FIG. 14 is a diagram showing a difference between a case where “010110” is transmitted by the modulation of FIG. 6 and a case where “010110” is transmitted by the modulation of FIG. 12.

### DESCRIPTION OF EMBODIMENTS

### First Embodiment

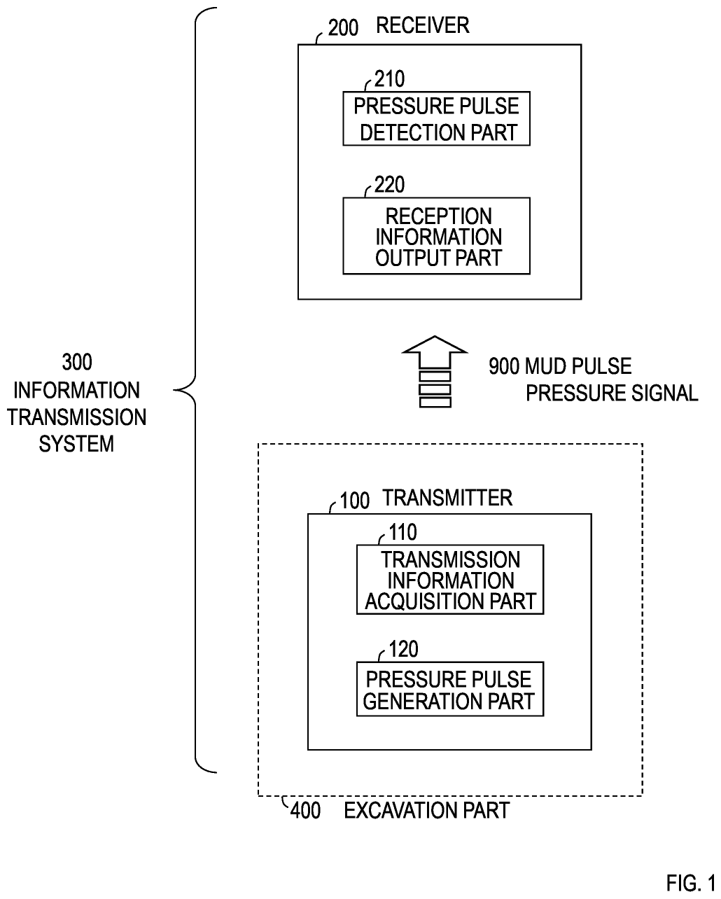

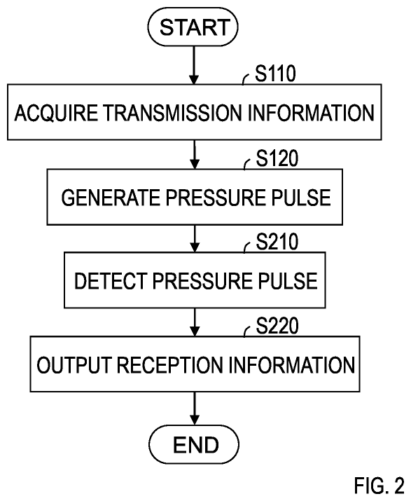

FIG. 1 shows a configuration example of an information transmission system of the present invention. FIG. 2 shows a processing flow using the information transmission system of the present invention. An information transmission system 300 transmits information by using a mud pulse pressure signal 900 (a signal to be transmitted in the form of a pressure pulse using mud as a transmission medium) to transmit information between a transmitter 100 located in an excavation part 400 of an underground excavator and a receiver 200 located on the ground. In other words, the information transmission system 300 uses a difference in mud pressure as a signal, and transmits information by a pressure-changed pulse (pressure pulse). Pressure is applied to mud from the ground side for excavation. When the resistance to flow of mud is changed on the excavation part 400 side, the pressure of the mud changes. The pressure pulse may be generated by changing the resistance to the flow of mud.

The transmitter 100 comprises a transmission information acquisition part 110 for acquiring information, and a pressure pulse generation part 120. Although not shown, the excavation part 400 includes an information processing device for obtaining information such as a tilt angle, an azimuth angle, a dip angle, and a tool face of the excavation part 400 from data which have been obtained from an acceleration sensor, a magnetic sensor, a temperature sensor, and the like. The transmission information acquisition part 110 acquires information to be transmitted to the ground from the information processing device, etc. (S110). The information to be acquired may be the tilt angle, the azimuth angle, the dip angle, the tool face, and the temperature themselves, or information on differences from previously-transmitted information. Since the communication speed based on the mud pulse is very slow as described above, it is advisable to take appropriate measures to reduce the amount of information (number of bits) to be transmitted as much as possible.

The pressure pulse generation part 120 generates a pressure pulse so that the interval between the pressure pulse and a just preceding or just subsequent pressure pulse is an interval corresponding to information acquired by the transmission information acquisition part 110 (S120). “A just preceding pressure pulse” means that a pressure pulse just before the pressure pulse of interest. “A just subsequent pressure pulse” means that a pressure pulse just after the pressure pulse of interest. The pressure pulse generation part 120 may be configured to consume electric power when generating a pressure pulse. Conversely, the pressure pulse generation part 120 may be configured to consume no electric power when generating no pressure pulse. In the case of a modulation method in which a period of time during which no pressure pulse is generated is longer, the power consumption can be reduced by performing such setting that electric power is consumed only when a pressure pulse is generated. Further, the pressure pulse generation part 120 may be configured to generate a pressure pulse having a predetermined certain pulse width. In particular, in the case of the setting that electric power is consumed only when a pressure pulse is generated, by setting “the predetermined certain pulse width” to a minimum pulse width that enables the pressure pulse detection part 210 of the receiver 200 to detect a pressure pulse, it makes it easy to reduce power consumption. However, if there is little need to reduce power consumption, other methods may be used. Further, a method of consuming electric power when the presence or absence of a pressure pulse is altered, and the like may be adopted.

The receiver 200 comprises a pressure pulse detection part 210 and a reception information output part 220. The pressure pulse detection part 210 detects a pressure pulse (S210). The reception information output part 220 outputs information corresponding to the interval between a detected pressure pulse and a pressure pulse just before or just after the detected pressure pulse (S220). It may be appropriately selected whether the interval between the detected pressure pulse and the just preceding pressure pulse is made to correspond to the information or the interval between the detected pressure pulse and the just subsequent pressure pulse is made to correspond to the information.

In the modulation adopted in the present invention, the interval between pressure pulses is made to correspond to information to be transmitted. In particular, when the pressure pulse generation part 120 consumes electric power only when generating a pressure pulse, this modulation is characterized in that the period of time during which no electric power is consumed corresponds to the information to be transmitted. In other words, a period of time during which the excavation part 400 does not execute the control of changing the mud pressure corresponds to the information.

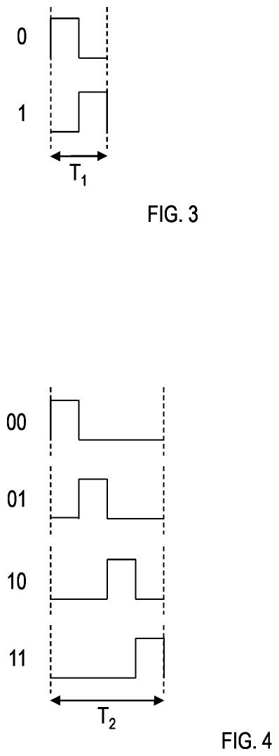

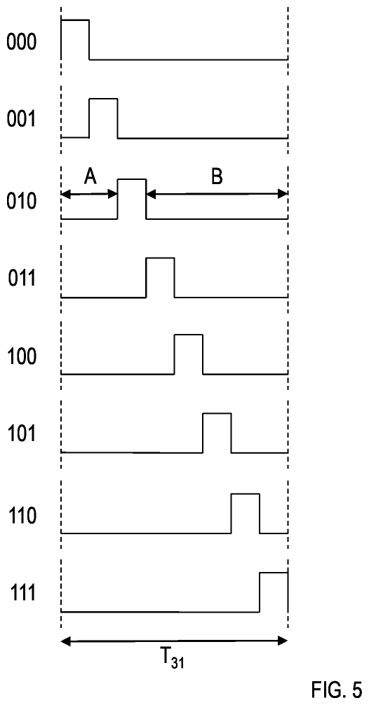

Next, the pulse position modulation and the modulation adopted by the present invention will be described. FIG. 3 shows an example in which 1-bit information is subjected to pulse position modulation. In FIG. 3, the pulse position is different between the case of “0” and the case of “1”. In this example, a period of time T₁ is required to transmit 1 bit. FIG. 4 shows an example in which 2-bit information is subjected to pulse position modulation. In FIG. 4, the pulse position is different among the cases of “00”, “01”, “10”, and “11”. In this example, a period of time T₂ is required to transmit 2 bits. FIG. 5 shows an example in which 3-bit information is subjected to pulse position modulation. In FIG. 5, the pulse position is different among the cases of “000”, “001”, “010”, “011”, “100”, “101”, “110”, and “111”. In this example, a period of time T₃₁ is required to transmit 3 bits. Further, a period of time A before a pulse and a period of time B after the pulse determine the position of the pulse.

In the examples of FIGS. 3 to 5, T₂=2×T₁, T₃₁=2×T₂=4×T₁. Likewise, a period of time T₄ required when 4-bit information is subjected to pulse position modulation satisfies T₄=2×T₃₁=4×T₂=8×T₁. A period of time Tₙ required when n-bit information is likewise subjected to pulse position modulation satisfies Tₙ=2ⁿ⁻¹×T₁. Therefore, when a large number of bits are subjected to pulse position modulation in a lump, the amount of information that can be transmitted per unit time is reduced (the communication speed slows down). On the other hand, in the case where power is consumed only when a pulse is transmitted, 3 bits can be transmitted in the example of FIG. 5 with the power to be consumed for transmission of 1 bit in the example of FIG. 3. In other words, when a large number of bits are subjected to pulse position modulation in a lump, the power required to transmit 1-bit information can be reduced. As described above, the pulse position modulation has a disadvantage that the communication speed becomes slow, but has an advantage that the power consumption of the transmitter which is installed in the excavation part 400 and operates with a battery can be easily reduced.

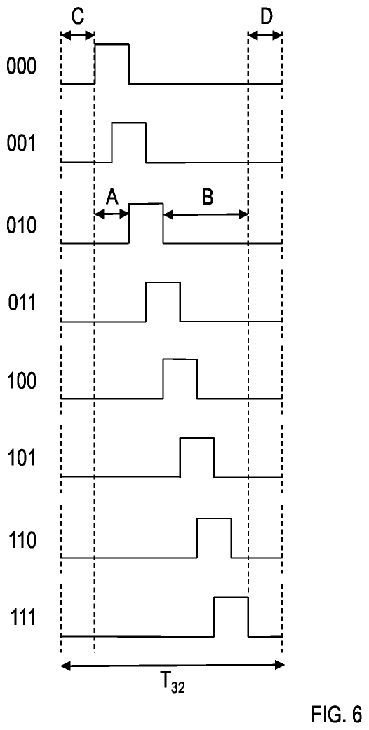

FIG. 6 shows another example in which 3-bit information is subjected to pulse position modulation. In FIG. 6, the pulse position is likewise different among the cases of “000”, “001”, “010”, “011”, “100”, “101”, “110”, and “111”. In FIG. 6, a period of time C and a period of time D in which no pulse exists are present regardless of the information to be transmitted, and a period of time A before a pulse and a period of time B after the pulse determine the position of the pulse. In the example of FIG. 5, the period of time C and the period of time D in which no pulse exists are not shown, but it is general to set the period of time C and the period of time D for detection of timing or the like. Further, in the example of FIG. 6, the pulse position is changed with a half of the width of the pulse being set as a unit. In this example, a period of time T₃₂ is required to transmit 3 bits.

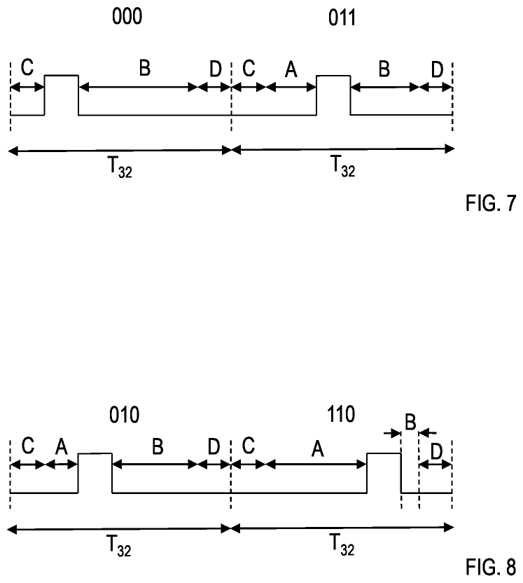

FIG. 7 shows pulses in the case where “000011” is transmitted by the pulse position modulation shown in FIG. 6. FIG. 8 shows pulses in the case where “010110” is transmitted by the pulse position modulation shown in FIG. 6. In both the cases, 6 bits are transmitted in a period of time of 2×T₃₂.

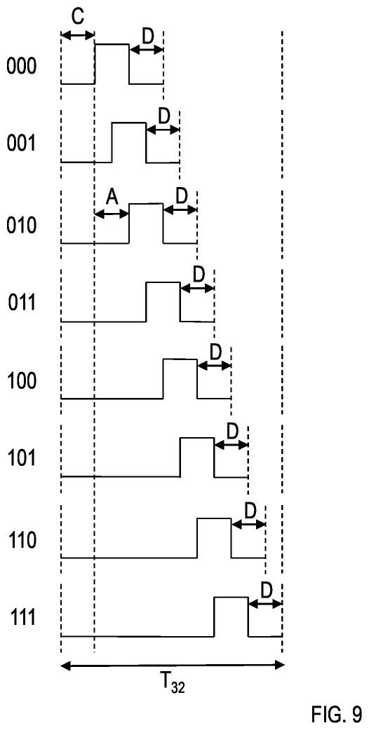

FIG. 9 shows an example of a modulation method that specifies information based on a period of time before a pulse. In the example of FIG. 9, the period of time A before each pulse is different among the cases of “000”, “001”, “010”, “011”, “100”, “101”, “110”, and “111”, and each signal ends when a certain period of time D has elapsed after the pulse. Therefore, in the case of “111” which is the longest signal, the period of time required to transmit 3 bits is T₃₂, but in the other cases, 3-bit information can be transmitted in a period of time shorter than T₃₂.

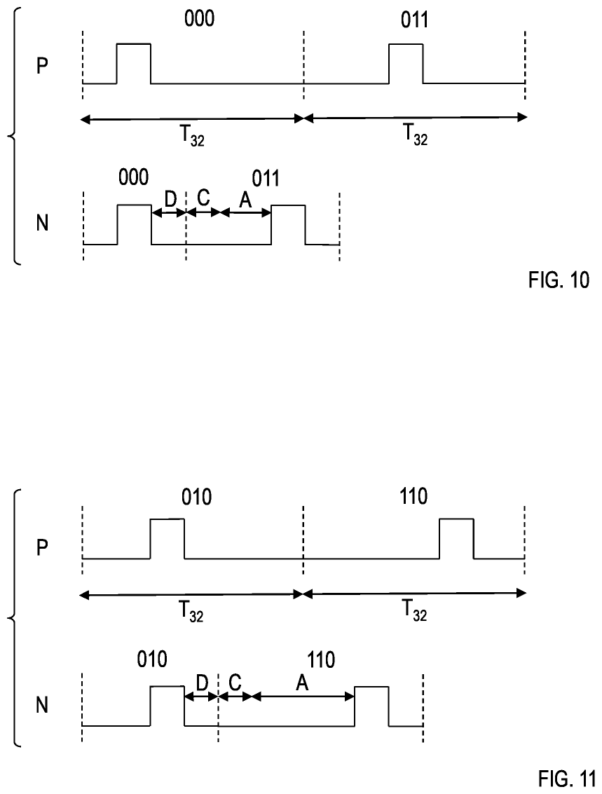

FIG. 10 shows the difference between a case where “000011” is transmitted by the modulation of FIG. 6 and a case where “000011” is transmitted by the modulation of FIG. 9. FIG. 11 shows the difference between a case where “010110” is transmitted by the modulation of FIG. 6 and a case where “010110” is transmitted by the modulation of FIG. 9. In both the figures, “P” represents the case of the modulation of FIG. 6, and “N” represents the case of the modulation of FIG. 9. In both the cases, it can be seen that the period of time required to transmit 6-bit information is shortened. Note that it is the same in both the examples of FIGS. 6 and 9 to send two pulses for transmission of 6-bit information. Therefore, the electric power required to transmit 1-bit information is the same in both the examples.

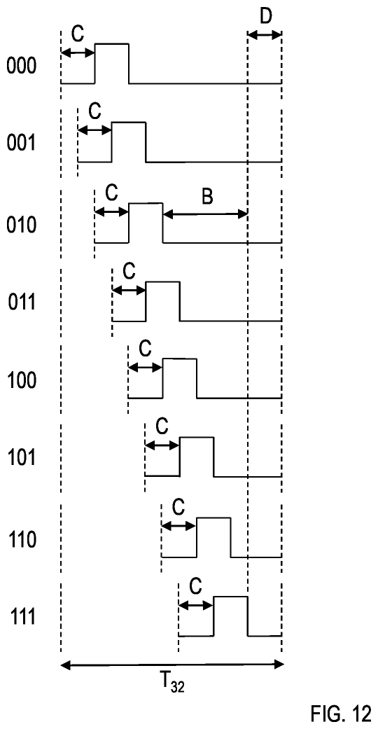

FIG. 12 shows an example of a modulation method that specifies information by a period of time after a pulse. In the example of FIG. 12, a period of time B after a pulse is different among the cases of “000”, “001”, “010”, “011”, “100”, “101”, “110”, and “111”, a certain period of time C exists before each pulse. In the example of FIG. 2, the period of time required to transmit 3 bits is T₃₂ in the case of “000” which is the longest signal, but in the other cases, 3-bit information can be transmitted in a period of time shorter than T₃₂.

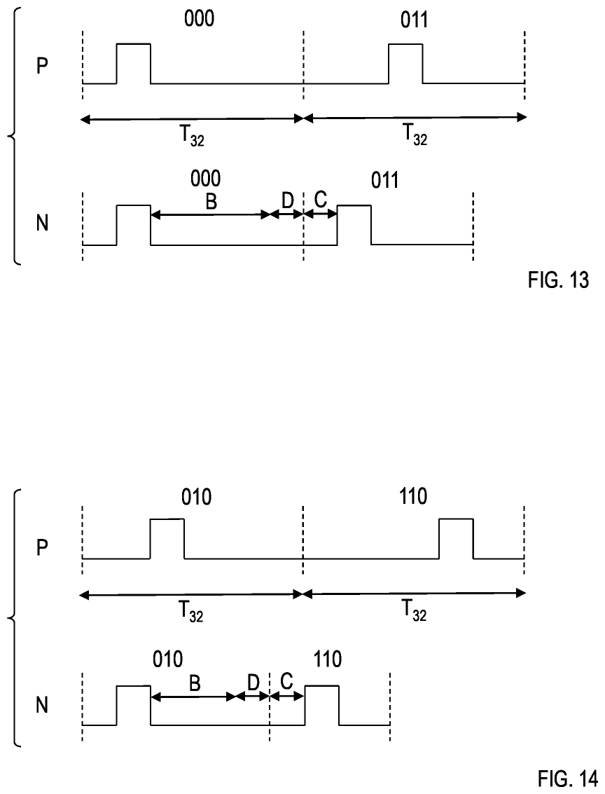

FIG. 13 shows the difference between a case where “000011” is transmitted by the modulation of FIG. 6 and a case where “000011” is transmitted by the modulation of FIG. 12. FIG. 14 shows the difference between a case where “010110” is transmitted by the modulation of FIG. 6 and a case where “010110” is transmitted by the modulation of FIG. 12. In both the figures, “P” represents the case of the modulation of FIG. 6, and “N” represents the case of the modulation of FIG. 12. In both the cases, it can be seen that the period of time required to transmit 6-bit information is shortened. Note that it is the same in both the examples of FIGS. 6 and 12 to send two pulses for transmission of 6-bit information. Therefore, the electric power required to transmit 1-bit information is the same in both the examples.

When applied to the information transmission system 300 of the present invention, the modulation of FIG. 9 is the modulation in the case where an interval from a just preceding pressure pulse is made to correspond to information. For example, in the example of FIG. 10, the period of time D+C+A is an interval from a just preceding pressure pulse, and it corresponds to information “011”. In the example of FIG. 11, the period of time D+C+A is an interval from a just preceding pressure pulse, and it corresponds to information “110”. Further, the modulation of FIG. 12 is the modulation in the case where an interval from a just subsequent pressure pulse is made to correspond to information. For example, in the example of FIG. 13, the period of time B+D+C is an interval from a just preceding pressure pulse, and it corresponds to information “000”. In the example of FIG. 14, the period of time B+D+C is an interval from a just subsequent pressure pulse, and it corresponds to information “010”.

In the description with reference to FIGS. 9 to 14, one pulse is used for 3-bit information. However, the number of bits of information to be transmitted by one pulse may be appropriately determined. Further, the above description has been made on the assumption that an interval between the falling edge of a preceding pressure pulse and the rising edge of a subsequent pressure pulse is defined as the interval between the pressure pulses. However, an interval between the rising edge of a preceding pressure pulse and the rising edge of a subsequent pressure pulse may be interpreted as the interval between the pressure pulses. In this way, it may be appropriately determined from which position of a preceding pressure pulse to which position of a subsequent pressure pulse is interpreted as the interval between the pressure pulses.

In the pulse position modulation, information is transmitted according to a timing (position) at which a pulse exists in a certain period of time. Therefore, time from the generation of a pulse until the end of the certain period of time is a standby time for waiting the start of a next certain period of time. In particular, when the position of a pulse exists at an early timing in the certain period of time, the standby time becomes longer. Further, when the position of a pulse is indicated by the time after the generation of the pulse until the end of the certain period of time, the time until the pulse has been generated is a standby time. At this time, when the position of a pulse exists at a later timing in the certain period of time, the standby time becomes longer. In the information transmission system of the present invention, an interval from a just preceding or just subsequent pressure pulse is made to correspond to information to be transmitted. Therefore, the standby time can be eliminated, so that the communication speed can be improved. Further, since the number of bits that can be transmitted by one pulse is the same, the power consumption required to transmit 1-bit information is the same as the pulse position modulation.

1. An information transmission system for transmitting information as a pressure pulse by using a mud pulse pressure signal to transmit information between a transmitter located in an excavation part of an underground excavator and a receiver located on ground, the system comprising:
the transmitter; and
the receiver;
wherein the transmitter comprises:
a transmission information acquirer for acquiring information; and
a pressure pulse generator for generating a pressure pulse so that an interval between the pressure pulse and a just preceding pressure pulse is an interval corresponding to the information acquired by the transmission information acquirer, and wherein the receiver comprises:
a pressure pulse detector for detecting the pressure pulse; and
a reception information output for outputting information corresponding to an interval between the detected pressure pulse and the just preceding pressure pulse,
wherein the pressure pulse generator consumes electric power when generating a pressure pulse, and
wherein the pressure pulse generator generates a pressure pulse having a predetermined fixed pulse width.

2. An information transmission system for transmitting information as a pressure pulse by using a mud pulse pressure signal to transmit information between a transmitter located in an excavation part of an underground excavator and a receiver located on ground, the system comprising:
the transmitter; and
the receiver;
wherein the transmitter comprises:
a transmission information acquirer for acquiring information; and
a pressure pulse generator for generating a pressure pulse so that an interval between the pressure pulse and a just subsequent pressure pulse is an interval corresponding to the information acquired by the transmission information acquirer, and wherein the receiver comprises:
a pressure pulse detector for detecting the pressure pulse; and
a reception information output for outputting information corresponding to an interval between the detected pressure pulse and the just subsequent pressure pulse,
wherein the pressure pulse generator consumes electric power when generating a pressure pulse, and
wherein the pressure pulse generator generates a pressure pulse having a predetermined fixed pulse width.

3. A transmitter that is located in an excavation part of an underground excavator and transmits information as a pressure pulse by using a mud pulse pressure signal, comprising:
a transmission information acquirer for acquiring information; and
a pressure pulse generator for generating a pressure pulse so that an interval between the pressure pulse and a just preceding or just subsequent pressure pulse is an interval corresponding to the information acquired by the transmission information acquirer,
wherein the pressure pulse generator consumes electric power when generating a pressure pulse, and
wherein the pressure pulse generator generates a pressure pulse having a predetermined fixed pulse width.

4-5. (canceled)

6. A receiver for receiving, on ground, information transmitted from a transmitter that is located in an excavation part of an underground excavator and transmits information by using a mud pulse pressure signal, comprising:
a pressure pulse detector for detecting a pressure pulse; and
a reception information output for outputting information corresponding to an interval between the detected pressure pulse and a just preceding or just subsequent pressure pulse,
wherein the pressure pulse has a predetermined fixed pulse width.

7. An information transmission method for transmitting information as a pressure pulse by using a mud pulse pressure signal to transmit information between a transmitter located in an excavation part of an underground excavator and a receiver located on ground, the method comprising:
executing with the transmitter:
a transmission information acquisition of acquiring information; and
a pressure pulse generation of generating a pressure pulse so that an interval between the pressure pulse and a just preceding pressure pulse is an interval corresponding to the information acquired in the transmission information acquisition, and executing with the receiver:
a pressure pulse detection of detecting the pressure pulse; and
a reception information output of outputting information corresponding to an interval between the detected pressure pulse and the just preceding pressure pulse,
wherein the pressure pulse generation consumes electric power when generating a pressure pulse, and
wherein the pressure pulse generation generates a pressure pulse having a predetermined fixed pulse width.

8. An information transmission method for transmitting information as a pressure pulse by using a mud pulse pressure signal to transmit information between a transmitter located in an excavation part of an underground excavator and a receiver located on ground, the method comprising:
executing with the transmitter:
a transmission information acquisition of acquiring information; and
a pressure pulse generation of generating a pressure pulse so that an interval between the pressure pulse and a just subsequent pressure pulse is an interval corresponding to the information acquired in the transmission information acquisition, and executing with the receiver:
a pressure pulse detection of detecting the pressure pulse; and
a reception information output of outputting information corresponding to an interval between the detected pressure pulse and the just subsequent pressure pulse,
wherein the pressure pulse generation consumes electric power when generating a pressure pulse, and
wherein the pressure pulse generation generates a pressure pulse having a predetermined fixed pulse width.

9. The information transmission system according to claim 1, wherein the pulse width is a minimum pulse width that enables the pressure pulse detector to detect the pressure pulse.

10. The information transmission system according to claim 2, wherein the pulse width is a minimum pulse width that enables the pressure pulse detector to detect the pressure pulse.

11. The transmitter according to claim 3, wherein the pulse width is a minimum pulse width that enables the pressure pulse detector to detect the pressure pulse.

12. The receiver according to claim 6, wherein the pulse width is a minimum pulse width that enables the pressure pulse detector to detect the pressure pulse.
